(19) United States
(12) Patent Application Publication
(10) Pub. No.: US 2014/0027291 A1
(43) Pub. Date: Jan. 30, 2014

(54) LITHIUM-ION BATTERY PRECURSOR INCLUDING A SACRIFICIAL LITHIUM ELECTRODE AND A POSITIVE TEXTILE CONVERSION ELECTRODE

(71) Applicant: ELECTRICITE DE FRANCE, Paris (FR)

(72) Inventors: Elodie Vidal, Montigny Sur Loing (FR); Stephane Lascaud, Fontainebleau (FR)

(73) Assignee: ELECTRICITE DE FRANCE, Paris (FR)

(21) Appl. No.: 14/041,492

(22) Filed: Sep. 30, 2013

Related U.S. Application Data
(63) Continuation-in-part of application No. PCT/FR2012/050717, filed on Apr. 3, 2012.

(30) Foreign Application Priority Data
Apr. 6, 2011 (FR) 1152972

(51) Int. Cl. H01M 4/04; H01M 4/1395

(52) U.S. Cl. CPC H01M 4/045; H01M 4/1395
USPC 205/59; 429/142

(57) ABSTRACT

The invention relates to a lithium-ion accumulator precursor and to a method for producing an accumulator from such a precursor.

### CROSS-REFERENCE TO RELATED APPLICATIONS

This application is a continuation-in-part of International Patent Application No. PCT/FR2012/050717, filed Apr. 3, 2012, and published as WO 2012/136925, which in turn claims priority to FR 1152972, filed Apr. 6, 2011.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The invention relates to a precursor of a lithium-ion accumulator containing a sacrificial metallic-lithium electrode, and to a method for producing a lithium-ion accumulator from such a precursor.

### BACKGROUND

The terminology “lithium-ion” (Li-ion) generally defines a technology in which the cathode and the anode each comprise a material that reacts electrochemically and reversibly with lithium, and an electrolyte containing lithium ions. The materials that react electrochemically and reversibly with lithium are, for example, insertion materials, containing or not containing lithium, or carbon, or conversion materials. The electrolyte generally contains fluorinated salts of lithium in solution in an aprotic organic solvent.

French patent application FR 2 870 639 in the name of the Applicant describes an electrode for lithium-ion accumulators which is characterized by the presence, on the surface of the electron collector, of a layer of electrochemically active material which is “nanostructured”, containing nanoparticles composed of a compound, as for example a halide, of the metal or metals forming the electron collector. The particular structure of the electrochemically active material enhances the performance of the accumulators in terms of power and of energy density per unit mass.

French patent application FR 2 901 641, likewise in the name of the Applicant, describes an enhancement to the nanostructured electrode above, residing primarily in the textile structure of the electrode and of the half-accumulators (electrode+separator) manufactured from said electrode.

F. Badway et al. (F. Badway, N. Pereira, F. Cosandey, C. G. Amatucci, J. Electrochem. Soc., 150. A1209 (2003)) studied the reaction of lithium with metal fluorides such as ion fluorides or bismuth fluorides. This reaction leads to the conversion of the metal fluoride into a nanostructured layer of metal and of lithium fluoride. Iron fluorides in particular offer numerous advantages. To start with, the reaction of the iron fluorides with the lithium ions produces high theoretical capacities (571 mAh/g for FeF₂ and 712 mAh/g for FeF₃) as compared with the theoretical capacity of a conventional positive electrode material such as LiCoO₂ (274 mAh/g) and, in particular, the potential of this conversion reaction is compatible with use as a positive electrode in a lithium-ion battery. Furthermore, iron fluorides are not very expensive and have a low toxicity for the environment. In practice, with accumulators composed of a positive electrode based on FeF₃ nanocomposites (85% FeF₃/15% C) and a negative electrode made of metallic lithium, Badway et al. obtained a reversible capacity of 600 mAh/g on the composite, corresponding to a gain of 400% in relation to a conventional positive electrode based on LiCoO₂, at an average voltage of 2.2 V, corresponding to an ultimate energy gain of 200% with cycling at 70° C.

### SUMMARY OF THE INVENTION

The invention relates to a lithium-ion accumulator precursor comprising
one or more electrode modules each formed by
   (a) at least one textile positive electrode precursor, composed of a textile metallic structure, fluorinated or oxyfluorinated at the surface, based on one or more transition metals from groups 4 to 12 of the Periodic Table of the Elements,
   (b) a polymeric separator, impregnated with a solution of a lithium salt in an aprotic organic solvent, said separator covering the surface of the positive electrode precursor,
   (c) a negative electrode precursor forming a solid, preferably continuous, matrix which encloses the structure formed by (a) and (b), and
at least one sacrificial metallic lithium electrode, separated from the electrode module or modules by a polymeric separator impregnated with a solution of a lithium salt in an aprotic organic solvent,

characterized in that the ratio of the geometric surface area of the lithium strip to the cumulative geometric surface area of all of the textile positive electrode precursors is within the range from 0.05 to 0.33, preferably from 0.1 to 0.25.

The invention also relates to a method for producing an accumulator from such a precursor.

### BRIEF DESCRIPTION OF THE DRAWINGS

FIG. 1 represents an embodiment of an accumulator precursor of the present invention, and

FIGS. 2 and 3 represent the same accumulator precursor, respectively, during the first and second steps in the method for producing an accumulator of the present invention.

### DETAILED DESCRIPTION

The Applicant, in the context of its research aiming to perfect lithium-ion accumulators comprising nanostructured electrodes, has shown that it is possible for the skilled person to form a conversion layer based on iron fluoride or iron oxyfluoride by electrochemical treatment of a substrate based on iron. Said treatment is, for example, an anodic polarization at a potential of between 10 and 60 V/ENH (Standard Hydrogen Electrode) in a solution containing ammonium fluoride NH₄F at a concentration of between 0.05 mol/l and 0.1 mol/l in nonanhydrous ethylene glycol. This treatment is followed by a rinsing step in a solvent such as methanol and then by oven drying at a temperature of 120° C. for an hour. The resulting electrode has a conversion layer comprising iron fluoride.

The lithium-ion accumulators that utilize a positive electrode based on iron fluoride (or other metal fluorides or oxyfluorides) are, however, more complex than the conventional lithium-ion accumulators.

The reason is that when a nanostructured positive electrode of this kind in association with a negative electrode based, for example, on graphite is used for the manufacture of lithium-ion batteries, a problem with which one is faced is that the accumulator thus constituted is devoid of a lithium source.

The idea underlying the present invention is to use a sacrificial electrode as a source of lithium ions.

The use of sacrificial lithium electrodes for the manufacture of accumulators is already known.

For example, patent U.S. Pat. No. 5,871,863 discloses the use of a sacrificial lithium electrode with the aim of increasing the capacity, in terms of mass and volume, of positive electrodes based on lithiated manganese oxide (LiMn₂O₄), this material having a volume capacity that is lower by 10% to 20% than that of the LiCoO₂ material presented as reference material. A sacrificial lithium or lithium alloy strip is contacted directly or indirectly with the positive electrode composed of lithiated manganese oxide. In one embodiment an electron conductor is intercalated between the lithium strip and the positive electrode in order to limit the exothermic nature of the self-discharge reaction between these two elements in the presence of an electrolyte solution. This self-discharge reaction leads to the insertion of an additional amount of lithium ions into the positive electrode material. Owing to the sheet structure of the electrodes and of the accumulator, it is necessary, in order to guarantee uniform distribution of the lithium ions, to apply the strip to the whole of the surface of the positive electrode; in other words, the ratio between the geometric surface area of the lithium strip and the cumulative geometric surface area of the positive electrodes must not be too low and must ideally tend toward 1 (when the whole surface of the positive electrodes is covered by the lithium strip). The thickness of the strip used in the example of U.S. Pat. No. 5,871,863 is 30 μm.

The Applicant, in the context of its research aiming to perfect lithium-ion accumulators comprising nanostructured electrodes as described in FR 2 901 641, has found that, by virtue of the textile structure of the positive electrodes and by virtue of a particular arrangement of the various components of the accumulator, it was possible to use metallic lithium as a source of lithium, in a way which is much simpler than in the above-discussed patent U.S. Pat. No. 5,871,863.

The reason is that in the accumulator precursor of the present invention, described in detail hereinafter, the fact that the textile structure of the nanostructured positive electrodes, even when they are stacked on one another or wound around each other, allows the passage of lithium ions in all directions, and especially in a direction perpendicular to the plane of the textile electrodes, is exploited. The result is a regular diffusion of the lithium ions throughout the accumulator and/or accumulator precursor.

In the present invention, therefore, it is unnecessary to apply a lithium strip to each of the lithium-receiving electrodes (as in U.S. Pat. No. 5,871,863); instead, a single lithium strip, or a small number of strips, with a thickness that is relatively greater, is sufficient to introduce the desired amount of lithium in a regular way into all of the positive electrodes receiving lithium ions.

The present invention accordingly provides a lithium-ion accumulator precursor comprising not only one or more superposed nanostructured textile electrodes but also at least one sacrificial lithium electrode, in other words an electrode made of lithium or lithium alloy that will be partly or entirely consumed during the production of the definitive accumulator from the accumulator precursor.

The accumulator precursor of the present invention comprises
one or more electrode modules each formed by
   (a) at least one textile positive electrode precursor, composed of a textile metallic structure, fluorinated or oxyfluorinated at the surface, based on one or more transition metals from groups 4 to 12 of the Periodic Table of the Elements,
   (b) a polymeric separator, impregnated with a solution of a lithium salt in an aprotic organic solvent, said separator covering the entire surface of the textile positive electrode precursor (a),
   (c) a negative electrode precursor forming a solid, preferably continuous, matrix which encloses the structure formed by (a) and (b), and
at least one metallic lithium electrode, formed by a metallic lithium strip supported by an electrical conductor, and separated from the electrode module or modules by a polymeric separator impregnated with a solution of a lithium salt in an aprotic organic solvent, the ratio of the cumulative geometric surface area of the lithium strip or strips to the cumulative geometric surface area of all of the textile positive electrode precursors is within the range from 0.05 to 0.33, preferably from 0.1 to 0.25.

The accumulator precursor of the present invention thus comprises one or more “electrode modules” each composed of a negative electrode precursor that forms a matrix, preferably a continuous matrix, which encloses a textile positive electrode precursor or a stack of two or more textile positive electrode precursors, a polymeric separator impregnated with a liquid electrolyte coating the fibers of the positive electrode precursor and thus insulating it completely from the negative electrode precursor.

The negative electrode precursor comprises a lithium ion insertion material commonly used in lithium-ion accumulators. Materials of this kind are known to the skilled person. Examples of such materials include graphite, carbon, or titanium oxide. The negative electrode precursor further advantageously comprises a polymeric binder, preferably poly(vinylidene fluoride) (PVDF) or a copolymer of vinylidene fluoride and hexafluoropropylene (PVDF-HFP).

Each positive electrode precursor comprises
an electron collector containing one or more transition metals from groups 4 to 12 of the Periodic Table of the Elements, and
on the surface of the electron collector, a fluoride or oxyfluoride layer formed by chemical or electrochemical treatment of the electron collector.

During the production of the accumulator from the accumulator precursor of the present invention, the layer of fluoride or oxyfluoride of at least one transition metal on the surface of the electron collector will react with the lithium ions coming from the sacrificial lithium electrode, to form a nanostructured conversion layer. This nanostructured conversion layer, described in detail in patent applications FR 2 870 639 and FR 2 901 641, constitutes the electrochemically active material of the positive electrode of the lithium-ion accumulator. It contains nanoparticles having an average diameter of between 1 and 1000 nm, preferably between 10 and 300 nm, or agglomerates of such nanoparticles.

The transition metal or metals of the electron collector are preferably selected from the group consisting of nickel, cobalt, manganese, copper, chromium and iron, with iron being particularly preferred.

In one particularly preferred embodiment, the textile positive electrode precursor is made of unalloyed or low-alloy steel, fluorinated or oxyfluorinated at the surface.

The positive electrode precursor and the positive electrode have a textile structure, in other words a structure composed of a multitude of fibers which are juxtaposed and/or intermingled, in an ordered or disordered way. The structure in question may in particular be a woven textile structure or a non-woven textile structure.

The textile structure used to form the positive electrode precursor is preferably formed of very fine threads with little space between one another. The reason is that the finer the threads and the greater the number of threads per unit surface area, the higher the specific surface area (determined by BET or by electrochemical impedance spectroscopy). The fineness of the wires may, however, be limited by the capacity for the metals or metal alloys used to be drawn. Whereas certain metals and alloys, such as copper, aluminum, bronze, brass, and certain steels alloyed with chromium and with nickel, lend themselves very well to drawing and hence may be obtained in the form of very fine wires, other metals or alloys, such as ordinary steels, are more difficult to draw and are more suitable for structures having short fibers, such as nonwovens.

Generally speaking, the equivalent diameter of the cross section of the metallic wires or metallic fibers constituting the positive electrode precursor is between 5 μm and 1 mm, preferably between 10 μm and 100 μm and more particularly between 15 μm and 50 μm. By “equivalent diameter” is meant the diameter of the circle possessing the same surface area as the cross section of the wires or fibers.

In the positive electrode, the conversion layer (electrochemically active material) preferably covers the whole surface of the electron collector and preferably has a thickness of between 30 nm and 15 000 nm, more particularly between 30 nm and 12 000 nm.

The precursor of the textile positive electrode preferably has a non-woven structure formed of short fibers preferably having an average length of between 1 cm and 50 cm, preferably between 2 cm and 20 cm, and an equivalent diameter of between 5 μm and 50 μm.

The Applicant preferably uses steel wool felts that are available commercially. These felts preferably have a density of between 0.05 and 5 g/cm³, more particularly between 1 and 3 g/cm³, these values being those determined on a felt compressed by application of a pressure of 1 bar.

The positive electrode precursor, owing to its textile structure, is permeable to ions, and more particularly to the lithium ions coming from the sacrificial electrode. When this textile structure is very dense, it may be desirable to increase this permeability or “porosity” by making holes or openings in the textile structure, preferably distributed regularly over the entire surface of the textile structure. These holes then add to those which are naturally present in the textile structure. When reference is made, in the present patent application, to the “holes” or “openings” in the precursor of the positive textile electrode, this term always encompasses the openings intrinsic to the textile structure and those possibly produced, for example, by piercing of the textile structure.

The positive electrode precursor surface is covered over its entire surface with a polymeric coating which provides the function of a separator. In the accumulator precursor of the present invention, this polymeric coating is impregnated and swollen with an aprotic liquid electrolyte containing at least one lithium salt. In the present invention, the separator coating swollen with the liquid electrolyte is preferably thin enough for the textile structure of the positive electrode precursor to be always apparent. In other words, the application of the separator preferably does not completely block the openings, holes, or meshes in the textile structure, whether the latter is woven or non-woven.

The non-blocking of these holes by the separator is not, however, an essential technical characteristic of the invention, and the present invention will also function when the polymeric separator does completely block the openings in the textile electrode. The reason is that the separator impregnated with a solution of a lithium salt is permeable to the lithium ions coming from the sacrificial electrode and will therefore allow these ions to pass through during the first cycling.

The optional void in the positive electrode precursor covered with the separator will be filled in subsequently by the material of the negative electrode precursor, with the assembly formed by the positive electrode precursor, the separator impregnated with the liquid electrolyte, and the negative electrode precursor forming an electrode module. Accordingly, it is possible to define a degree of void of the positive electrode precursor covered with the separator which is equal to the volume of the negative electrode precursor of each electrode module related to the total volume of said electrode module. This void rate is preferably between 20% and 90%, preferably between 25% and 75%, and more particularly between 50% and 70%.

The thickness of each electrode module may vary very widely depending on the number of textile electrodes superposed on one another. The thickness is generally between 100 μm and 5 cm, preferably between 150 μm and 1 cm, and more particularly between 200 μm and 0.5 cm.

Although the application of a thin coating of separator on the textile positive electrode precursor may be carried out by various appropriate methods, such as immersion, spraying or chemical vapor deposition, this coating is preferably applied electrochemically and more particularly by a technique known by the name of cataphoresis. This technique, in which the metallic structure to be coated is introduced, as cathode, into an aqueous solution containing the base components of the coating to be applied, allows an extremely fine, regular, and continuous coating, covering the entire surface of a structure, even a structure with a highly complex geometry. In order to be able to migrate toward the cathode, in other words toward the textile structure, the component to be applied must have a positive charge. For example, the use of cationic monomers is known, which, following application to the cathode and polymerization, form an insoluble polymeric coating.

In one preferred embodiment of the accumulator precursor of the present invention, the separator is a separator applied by cataphoresis from an aqueous solution containing such cationic monomers, preferably cationic monomers containing quaternary ammonium functions. The separator is therefore preferably a polymeric coating formed by a polymer containing quaternary ammonium functions.

The lithium salts incorporated into the liquid electrolytes, which can be used in the lithium-ion accumulators, are known to the skilled person. They are generally fluorinated lithium salts. Examples include LiCF₃SO₃, LiClO₄, LiN(C₂F₅SO₂)₂, LiN(CF₃SO₂)₂, LiAsF₆, LiSbF₆, LiPF₆ and LiBF₄. Said salt is preferably selected from the group consisting of LiCF₃SO₃, LiClO₄, LiPF₆, and LiBF₄.

In general, said salt is dissolved in an anhydrous aprotic organic solvent composed generally of mixtures, in variable proportions, of propylene carbonate, dimethyl carbonate, and ethylene carbonate. Hence said electrolyte generally comprises, as is known to the skilled person, at least one cyclic or acyclic carbonate, preferably a cyclic carbonate. For example, said electrolyte is LP30, a commercial compound from the company Merck containing ethylene carbonate (EC), dimethyl carbonate (DMC), and LiPF₆, the solution containing one mole/liter of salt and identical amounts of each of the two solvents.

As explained before, the accumulator precursor of the present invention further contains at least one “sacrificial” metallic lithium electrode. This electrode is called sacrificial because, during the first formative cycling, during which the accumulator precursor of the present invention is converted to a lithium-ion accumulator, this electrode is partly or completely consumed. This sacrificial electrode is preferably formed by a strip of metallic lithium supported by an electrical conductor. This electrical conductor is, for example, a plate of copper, and acts as an electron collector from the lithium electrode.

The accumulator precursor of the present invention has the advantage that it is able to operate with commercial strips having standard thicknesses of between 50 μm and 150 μm. Owing to the free diffusion of the lithium ions through the textile positive electrode precursors, a single sufficiently thick strip, or two strips sandwiching one or more electrode modules, make it possible for all of the positive electrode precursors to be fed with a sufficient quantity of lithium ions.

The ratio between the cumulative geometric surface area of the lithium strip or strips and the cumulative geometric surface area of all of the textile positive electrode precursors is within the range from 0.05 to 0.33, preferably from 0.1 to 0.25. In other words, preference will be given, for one lithium strip, to using 3 to 20 positive textile electrodes, preferably 4 to 10 positive electrodes, with a geometrical surface area identical to that of the lithium strip.

In the case of wound electrode modules, the sacrificial lithium electrode may surround the wound structure and/or be located in the center of said structure.

There now follows a calculation example for the dimensions of the sacrificial electrode required in order to supply the appropriate amount of lithium:

For a 10 Ah accumulator precursor consisting of a stack of 25 Ah electrode modules, each of which is composed as follows: (a) 5 textile positive electrode precursors; b) a polymeric separator covering the entire surface of the textile positive electrode precursors; (c) a graphite-based negative electrode with a reversible capacity by mass of 340 mAh/g, a binder polymer, carbon, forming a solid matrix with a density of 1.7 g/cm³, with a capacity per unit volume (after impregnation with the electrolyte) of 405 mAh/cm³, and filling the free volume within the 5 positive electrode precursors with their separator (a)+(b).

Each positive electrode precursor has an apparent density of 2.3 g/cm³, a void rate of 64%, and thickness of 142 μm. It possesses a conversion layer composed of iron fluoride FeF₃ with a weight of 5 mg/cm² of geometric surface area. Its capacity per unit mass during cycling is 500 mAh/g of iron fluoride, and the capacity required to form the nanostructured conversion layer is 712 mAh/g. Each positive electrode precursor is coated with a separator layer swollen with the electrolyte, with a thickness of 5 μm. The assembly of positive electrode precursor with its separator (a)+(b) therefore has a thickness of 142+2*5=152 μm and a void rate of 41%.

On cycling, each module comprising 5 textile positive electrodes will have a capacity of 5*5 mg/cm²*500 mAh/g=12.5 mAh/cm². The thickness of a module of textile positive electrodes with their separator is 5×152=760 μm. The volume occupied by one module, in other words by the 5 textile positive electrode precursors with their separator, is

$$\frac{5000 mAh}{12.5 mAh / {cm}^{2}} * 760 \cdot {10}^{- 4} cm = 30.4 {cm}^{3} .$$

The void rate in the assembly of positive electrode precursor with its separator (a)+(b) is 41%, and so the free volume within the positive textile electrode precursor with its separator is 30.4*0.41=12.5 cm³. The capacity of the negative electrode precursor occupying this volume of 12.5 cm³ will be 12.5 cm³×405 mAh/cm³=5 Ah. This capacity is the same as that of the module of textile positive electrodes which is combined with it for harmonious functioning of the accumulator.

During the first electrochemical reduction of the textile positive electrode, it will be necessary to supply an amount of lithium ions corresponding to 712 mAh/g of conversion layer, i.e., 712 mAh/g*5 mg/cm²=3.56 mAh/cm².

Moreover, in order to place the negative electrode at a potential lower than that of the positive electrode and to supply the lithium ions which will remain trapped in the negative electrode during the first charge/discharge of the accumulator, it is advantageous to provide, by means of the sacrificial electrode, a capacity equal to approximately 10% of the capacity of the negative electrode, i.e., for each module of 12.5 mAh/cm², a capacity of 1.25 mAh/cm².

It is therefore appropriate to supply a capacity of 3.56 mAh/cm² to each of the 5 positive electrodes in the module, and 1.25 mAh/cm² to the negative electrode occupying the free volume of the positive electrode with its separator, giving a total capacity of 19.05 mAh/cm². A sacrificial metallic lithium electrode able to deliver this capacity by a process of electrochemical oxidation of the metallic lithium to form lithium ions must have a minimum thickness of

$$\frac{19.05}{1000} Ah / {cm}^{2} * \frac{1}{26.8 Ah / mol} * 6.9 g / mol * \frac{1}{0.54 g / {cm}^{3}} = 9.1 {.10}^{- 3} cm = 91$$

Accordingly, an accumulator precursor composed of two electrode modules will require the use of two lithium strips with a minimum thickness of 91 μm or else of a single lithium strip with a minimum thickness of 2*91=182 μm.

Furthermore, as already mentioned in the introduction, it may be of interest to oversize the sacrificial lithium electrode in such a way that it is not completely consumed during the step of conversion of the accumulator precursor. The reason is that this residual lithium electrode will be able to be used advantageously, at the end of life of the accumulator, to recover, in the form of metallic lithium, the lithium incorporated in the negative and positive electrodes of the accumulator, and hence to facilitate the recycling of the accumulator. The method of recovery of the lithium then comprises a number of steps:
(1) a step of complete recharge (i.e., complete extraction of the lithium ions) of the negative electrodes on the sacrificial electrode;
(2) a step of complete discharge (i.e., a complete extraction of the lithium ions) of the positive electrodes on the sacrificial electrode;
(3) a step of opening and removal of the electrolyte; and
(4) a step of recovery of the metallic lithium either by mechanical removal or by melting of the lithium at a temperature greater than 180° C. and recovery by gravitational flow.

The accumulator precursor of the present invention preferably comprises a plurality of electrode modules of planar form and of identical dimensions that are superposed in parallel to one another.

Two electrode modules are preferably separated by an electron collector, inserted between them, in electrical contact with the negative electrode precursor (c). So as not to prevent the free diffusion of the lithium ions coming from the sacrificial lithium electrode throughout all the electrode modules, the electron collector comprises a certain number of openings spread preferably uniformly over its entire surface. The electron collector of the negative electric precursor is, for example, a metallic grid or a metallic textile structure. The electron collector of the negative electrode precursor is preferably composed of copper. In one preferred embodiment, the electron collector is formed by one or more copper grids arranged parallel to the plane of the electrode module or modules and intercalated between them.

The voids or openings in the electron collector of the negative electrode precursor (c) are filled with the material of the negative electrode precursor, thus establishing a continuity of ion conduction between two adjacent electrode modules.

The metallic lithium strip forming the sacrificial electrode is preferably placed against the stack of electrode modules such that the plane of the strip is parallel to the plane of the electrode module or modules and hence parallel to the plane of the textile positive electrode precursors. As already mentioned above, the lithium strip is not in electrical contact with the negative electrode precursor; instead, an ion-conducting separator is inserted between the two.

In one preferred embodiment, a lithium strip, supported by an electron collector, is provided on either side of the stack of electrode modules. The lithium strip or strips preferably cover the entirety of one or of both main faces of the stack.

The lithium-ion accumulator precursor of the present invention is converted to an accumulator by a two-step method: (i) a first step of electrochemically reducing the positive electrode precursor or precursors by the sacrificial electrode. In the course of this step, the metallic lithium strip is partly consumed and the lithium ions migrate through the separator of the sacrificial electrode, the material of the negative electrode precursor, and the separator of the positive electrode toward the fluoride or oxyfluoride layer of the positive electrode precursor, with which layer they react to form the nanostructured conversion layer that constitutes the active material of the final positive electrode.

(ii) A second step of electrochemically reducing the negative electrode precursor by the sacrificial electrode. In the course of this step, the metallic lithium strip is consumed entirely or partly and the lithium ions migrate through the separator of the sacrificial electrode and become inserted in the material of the negative electrode. This step is continued until the potential of the negative electrode, measured relative to the sacrificial metallic lithium electrode, is less than 1.5 V.

The present invention accordingly provides a method for manufacturing a lithium-ion accumulator from a lithium-ion accumulator precursor as described above, said method involving:
(i) a step of electrochemically reducing the positive electrode precursor or precursors by the sacrificial metallic lithium electrode, this step comprising the application of a potential or a current between the positive electrode and the sacrificial metallic lithium electrode and effecting the partial or total consumption of the sacrificial metallic lithium electrode. In the course of this step, the sacrificial metallic lithium electrode is connected to the positive electrode precursor via their respective connectors (electron collectors) and a potential, generally of between 3.5 and 1.5 V, is applied so as to induce electrochemical oxidation of the sacrificial metallic lithium electrode, electrochemical reduction of the fluoride or oxyfluoride layer of the positive electrode precursor, and a slow diffusion of the lithium ions from the sacrificial metallic lithium electrode to the fluoride or oxyfluoride layer of the positive electrode precursor.
(ii) A second step of electrochemically reducing the negative electrode precursor by the sacrificial metallic lithium electrode. During this step a current is applied between the sacrificial metallic lithium electrode and the negative electrode precursor, in such a way as to induce electrochemical oxidation of the sacrificial metallic lithium electrode, electrochemical reduction of the negative electrode, until the potential of the negative electrode, measured relative to the sacrificial metallic lithium electrode, is less than 1.5 V.

These two steps may be carried out in this order, but also in the reverse order; that is, the step of reducing the precursor of the negative electrode by the sacrificial metallic lithium electrode may precede the step of reducing the positive electrode precursor by the sacrificial lithium electrode.

In one embodiment, the last step of the method is continued until the lithium electrode has completely disappeared.

In another embodiment, the step is stopped before complete disappearance of the lithium electrode, so as to conserve a residual lithium electrode which is useful, at the end of life of the accumulator, for the recycling of the lithium.

In the course of step (i), preference is given to applying a relatively high potential first of all and then an increasingly low potential. The potential applied is reduced thus preferably in stages—that is, the value of the potential is maintained for a given time until the current intensity becomes too low, and then the value of the potential is reduced, before being maintained again at this new value, until the current intensity has again reached a low value.

The attainment of this low current value corresponds to the attainment of a state in which the concentration of lithium ions in the accumulator is sufficiently homogeneous, in other words in which the concentration gradient of lithium ions (necessary for the passage of the current) in the accumulator is low. This signifies that the various positive electrode precursors have reached the same level of potential relative to the sacrificial lithium electrode. The method involving successive decreasing stages in potential thus makes it possible to allow the lithium ions the time to diffuse inside the accumulator precursor and therefore to the different positive electrode precursors which make up this accumulator precursor, and to do so at each stage of applied potential.

In the same way, in the course of step (ii), preference will be given to applying a potential which is relatively high to start with and then increasingly low, until the desired potential is attained.

When the sacrificial metallic lithium electrode has been completely consumed or when the desired amount of lithium ions has been provided to the positive electrode precursor, for its fluoride or oxyfluoride layer to have been converted into a nanostructured conversion layer, and when the negative electrode precursor has been supplied with the amount of lithium ions necessary to attain a potential of less than 1.5 V relative to the sacrificial metallic lithium electrode, the positive textile electrode or electrodes are connected, via a current source or potential source, to the current collectors of the negative electrode, and the accumulator is given a first charge by passing a current through it until the end-of-charge potential of the accumulator has been reached.

### EXAMPLES

### Example 1

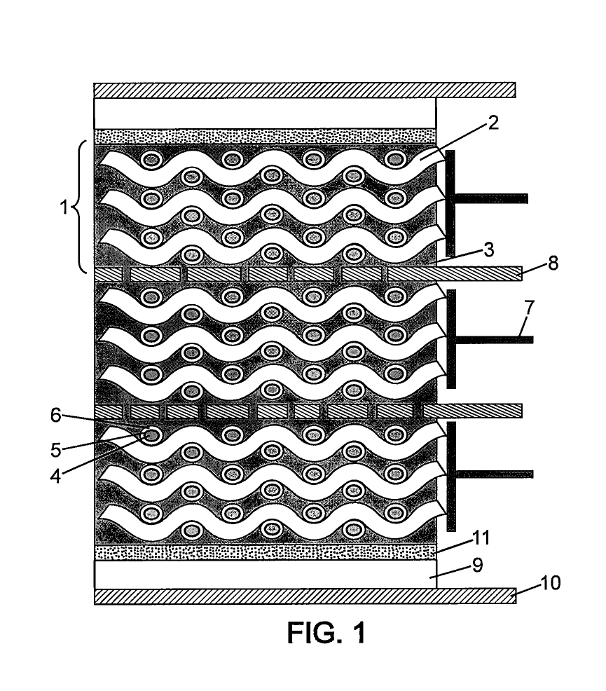

The accumulator precursor shown in FIG. 1 comprises three electrode modules 1 each comprising three positive electrode precursors 2 stacked one upon another. The positive electrode precursors here have a woven textile structure with weft wires shown in transverse section and warp wires in longitudinal section. Each wire of positive electrode precursor comprises a central metallic portion 4, surrounded by a metal fluoride or oxyfluoride layer 5, said metal fluoride or oxyfluoride layer being covered in turn by a thin separator layer 6.

The wires 2 of the positive electrodes are enclosed in a solid, continuous matrix forming the negative electrode precursor 3. The positive electrode precursors 2 are joined to electrical connectors 7 and the negative electrode precursor 3 is in electrical contact with the electrical connectors 8. The electrical connectors 8 of the negative electrode precursor are copper grids disposed alternately with the electrode modules 1. The material of the negative electrode precursor 3 not only completely surrounds the wires of the positive electrode precursors 2 but also fills the voids in the electrical connectors 8 of the negative electrode precursor, thereby producing a continuous network of negative electrode precursor extending throughout the volume of the accumulator. The accumulator precursor shown here comprises two sacrificial electrodes each formed by a strip 9 of metallic lithium applied to a metal connector 10. The strip of metallic lithium is separated from the negative electrode precursor 3 by a thin layer of a separator 11.

### Example 2

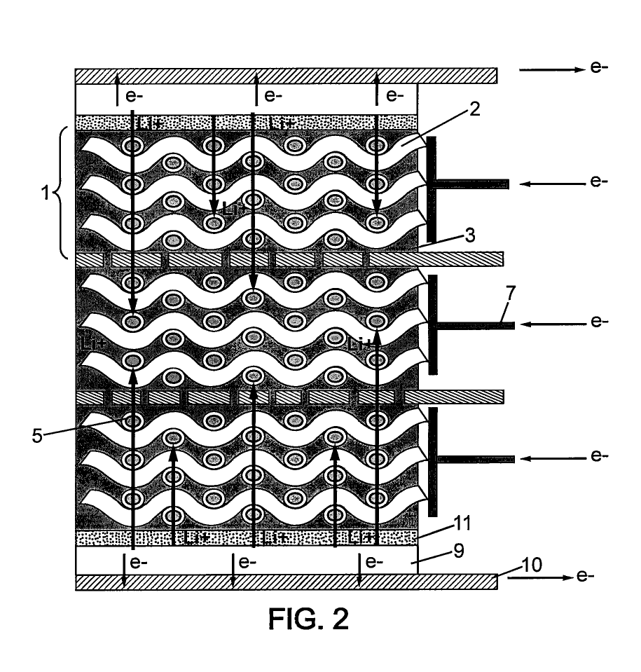

FIG. 2 shows the electrochemical process during the first step of conversion of the accumulator precursor to an accumulator. Application of a potential between the connectors 7 of the positive electrode precursors 2 and the connectors 10 of the sacrificial electrode 9 causes the migration of the lithium ions from the sacrificial electrode 9 via the negative electrode to the metal fluoride or oxyfluoride layer 5 of the positive electrode precursor 2. At the end of this step, the fluoride or oxyfluoride layer has been converted into a nanostructured conversion layer.

### Example 3

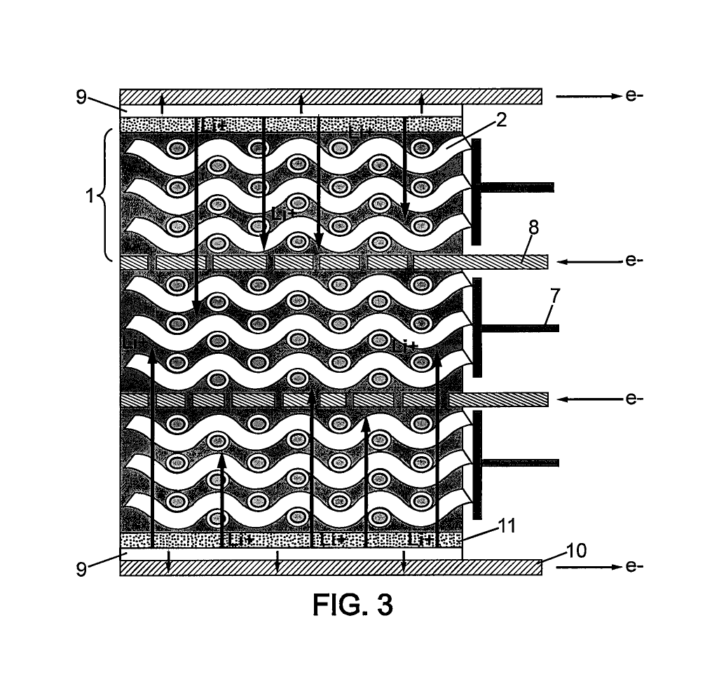

FIG. 3 shows the electrochemical process during the second step of the method of the invention. Application of a potential or of a current between the connectors 8 of the negative electrode precursors 3 and the connectors 10 of the sacrificial electrode 9 causes the migration of the lithium ions from the sacrificial electrode 9 to the negative electrode precursor 2. At the end of this step, in other words when the potential of the negative electrode, measured relative to the metallic lithium of the sacrificial electrode, has reached a value lower than the potential of the positive electrode measured relative to the metallic lithium of the sacrificial electrode at the end of step (i), the sacrificial electrode 9 has almost completely disappeared. The connectors 7 of the positive electrode precursors 2 may then be joined, via a voltage source or current source, to the connectors 8 of the negative electrode 3 for the first charging of the accumulator. The lithium ions of the positive electrode then migrate to the negative electrode.

The invention will be further described by the following numbered paragraphs:

1. A lithium-ion accumulator precursor, comprising
one or more electrode modules (1) each formed by
   (a) at least one textile positive electrode precursor (2), composed of a textile metallic structure (4), fluorinated or oxyfluorinated at the surface (5), based on one or more transition metals from groups 4 to 12 of the Periodic Table of the Elements,
   (b) a polymeric separator (6), impregnated with a solution of a lithium salt in an aprotic organic solvent, said separator covering the entire surface of the textile positive electrode precursor,
   (c) a negative electrode precursor (3) forming a solid, preferably continuous, matrix which encloses the structure formed by (a) and (b), and
at least one sacrificial metallic lithium electrode, formed by a metallic lithium strip (9) supported by an electrical conductor (10), and separated from the electrode module or modules by a polymeric separator (11) impregnated with a solution of a lithium salt in an aprotic organic solvent, characterized in that the ratio of the geometric surface area of the lithium strip to the cumulative geometric surface area of all of the textile positive electrode precursors is within the range from 0.05 to 0.33, preferably from 0.1 to 0.25.

2. The accumulator precursor according to paragraph 1, wherein the surface-fluorinated or surface-oxyfluorinated metallic textile structure is a non-woven structure formed of short fibers preferably having an average length of between 1 cm and 50 cm, preferably between 2 cm and 20 cm, and an equivalent diameter of between 5 μm and 50 μm.

3. The accumulator precursor according to paragraph 1, wherein the textile metallic structure is made of unalloyed or low-alloy steel.

4. The accumulator precursor according to paragraph 1, wherein a plurality of plane-shaped electrode modules of identical dimensions are superposed in parallel with one another.

5. The accumulator precursor according to paragraph 1, wherein the plane of the lithium strip of the sacrificial metallic lithium electrode is parallel to the plane of the electrode module or modules.

6. The accumulator precursor according to paragraph 1, further comprising an electron collector (8), in electrical contact with the negative electrode precursor (c) of each of the electrode modules, said electron collector being preferably formed by one or more copper grids arranged parallel to the plane of the electrode module or modules and intercalated between them.

7. A method for producing a lithium-ion accumulator from a lithium-ion accumulator precursor, comprising the steps of:
(i) electrochemically reducing the positive electrode precursor or precursors by the sacrificial metallic lithium electrode, this step comprising the application of a potential or a current between the positive electrode and the sacrificial metallic lithium electrode and leading to the partial or total consumption of the sacrificial metallic lithium electrode, until the fluoride or oxyfluoride layer of the positive electrode precursors has been partly or totally converted into a nanostructured conversion layer; and
(ii) electrochemically reducing the precursor of the negative electrode by the sacrificial metallic lithium electrode of the accumulator precursor, this step comprising the passing of a current from the sacrificial metallic lithium electrode to the negative electrode until the negative electrode has a potential, measured relative to the sacrificial metallic lithium electrode, of less than 1.5 V,

it being possible for these two steps to be carried out in this order or in the reverse order.

8. The method according to paragraph 7, wherein steps (i) and (ii) are continued until complete disappearance of the sacrificial metallic lithium electrode.

9. The method according to paragraph 7, wherein steps (i) and (ii) are halted before complete disappearance of the sacrificial metallic lithium electrode.

10. The according to paragraph 7, wherein during the electrochemical reduction of the positive electrode precursor or precursors, an increasingly low potential is applied, the applied potential being reduced preferably in stages.

It is to be understood that the invention is not limited to the particular embodiments of the invention described above, as variations of the particular embodiments may be made and still fall within the scope of the appended claims.

1. A lithium-ion accumulator precursor, comprising
one or more electrode modules (1) each formed by
(a) at least one textile positive electrode precursor (2), composed of a textile metallic structure (4), fluorinated or oxyfluorinated at the surface (5), based on one or more transition metals from groups 4 to 12 of the Periodic Table of the Elements,
(b) a polymeric separator (6), impregnated with a solution of a lithium salt in an aprotic organic solvent, said separator covering the entire surface of the textile positive electrode precursor,
(c) a negative electrode precursor (3) forming a solid, preferably continuous, matrix which encloses the structure formed by (a) and (b), and at least one sacrificial metallic lithium electrode, formed by a metallic lithium strip (9) supported by an electrical conductor (10), and separated from the electrode module or modules by a polymeric separator (11) impregnated with a solution of a lithium salt in an aprotic organic solvent, characterized in that the ratio of the geometric surface area of the lithium strip to the cumulative geometric surface area of all of the textile positive electrode precursors is within the range from 0.05 to 0.33, preferably from 0.1 to 0.25.

2. The accumulator precursor as claimed in claim 1, wherein the surface-fluorinated or surface-oxyfluorinated metallic textile structure is a non-woven structure formed of short fibers preferably having an average length of between 1 cm and 50 cm, preferably between 2 cm and 20 cm, and an equivalent diameter of between 5 μm and 50 μm.

3. The accumulator precursor as claimed in claim 1, wherein the textile metallic structure is made of unalloyed or low-alloy steel.

4. The accumulator precursor as claimed in claim 1, wherein a plurality of plane-shaped electrode modules of identical dimensions are superposed in parallel with one another.

5. The accumulator precursor as claimed in claim 1, wherein the plane of the lithium strip of the sacrificial metallic lithium electrode is parallel to the plane of the electrode module or modules.

6. The accumulator precursor as claimed in claim 1, further comprising an electron collector (8), in electrical contact with the negative electrode precursor (c) of each of the electrode modules, said electron collector being preferably formed by one or more copper grids arranged parallel to the plane of the electrode module or modules and intercalated between them.

7. A method for producing a lithium-ion accumulator from a lithium-ion accumulator precursor, comprising the steps of:
(i) electrochemically reducing the positive electrode precursor or precursors by the sacrificial metallic lithium electrode, this step comprising the application of a potential or a current between the positive electrode and the sacrificial metallic lithium electrode and leading to the partial or total consumption of the sacrificial metallic lithium electrode, until the fluoride or oxyfluoride layer of the positive electrode precursors has been partly or totally converted into a nanostructured conversion layer; and
(ii) electrochemically reducing the precursor of the negative electrode by the sacrificial metallic lithium electrode of the accumulator precursor, this step comprising the passing of a current from the sacrificial metallic lithium electrode to the negative electrode until the negative electrode has a potential, measured relative to the sacrificial metallic lithium electrode, of less than 1.5 V,
it being possible for these two steps to be carried out in this order or in the reverse order.

8. The method as claimed in claim 7, wherein steps (i) and (ii) are continued until complete disappearance of the sacrificial metallic lithium electrode.

9. The method as claimed in claim 7, wherein steps (i) and (ii) are halted before complete disappearance of the sacrificial metallic lithium electrode.

10. The as claimed in claim 7, wherein during the electrochemical reduction of the positive electrode precursor or precursors, an increasingly low potential is applied, the applied potential being reduced preferably in stages.
